(19) United States
(12) Patent Application Publication
(10) Pub. No.: US 2024/0331916 A1
(43) Pub. Date: Oct. 3, 2024

(54) INDUCTOR

(71) Applicant: HONDA MOTOR CO., LTD., Tokyo (JP)

(72) Inventor: Yusuke SHINDO, Saitama (JP)

(21) Appl. No.: 18/585,079

(22) Filed: Feb. 23, 2024

(30) Foreign Application Priority Data
Mar. 30, 2023 (JP) 2023-055881

(51) Int. Cl. H01F 27/24; H01F 27/16; H01F 27/30; H02M 3/155; H02M 3/335

(52) U.S. Cl. CPC H01F 27/24; H01F 27/16; H01F 27/306; H02M 3/155; H02M 3/33573

(57) ABSTRACT

The objective is to adjust the magnetic resistance at each coil mounting part to the desired level. The inductor includes a core and coils. The core includes the coil mounting parts extending in the Y direction and arranged in the X direction. The coils are externally fitted around each coil mounting part. The positions of the end faces on the Z− direction side of the coil mounting parts are aligned in the Z direction. The position of the end face on the Z+ direction side of at least a predetermined coil mounting part and the position of the end face on the Z+ direction side of another coil mounting part are different from each other in the Z direction. The cross-sectional area of the predetermined coil mounting part and the cross-sectional area of another coil mounting part are different from each other when viewed in the Y direction.

This application is based on and claims the benefit of priority from Japanese Patent Application No. 2023-055881, filed on 30 Mar. 2023, the content of which is incorporated herein by reference.

### BACKGROUND OF THE INVENTION

### Field of the Invention

The present invention relates to an inductor that includes a core with coil mounting parts arranged in a predetermined direction, and coils, each coil being externally fitted around each of the coil mounting parts.

### Related Art

Some inductors are designed such that the core is divided into a plurality of core split bodies, and magnetic resistance at each coil mounting part is adjusted to a desired level by providing a gap between the core split bodies at each coil mounting part.
Patent Document 1: Japanese Unexamined Patent Application, Publication No. 2017-195726

### SUMMARY OF THE INVENTION

However, the inventors have focused on the following points. When attempting to adjust the magnetic resistance to a desired level as mentioned above, the assembly of the inductor requires a process of inserting and adhering a member to form a gap, which increases the number of steps and the effort involved. Furthermore, when the gap to be managed is thin, accurate adjustment to the desired size is difficult.

The present invention has been made in view of the above circumstances with the objective to adjust the magnetic resistance at each coil mounting part to a desired level without providing a gap between the core split bodies.

The inventors have arrived at the present invention by finding that the above objective can be achieved by using one end of each coil mounting part in the cross-sectional view as the base to adjust the position of another end, thereby adjusting the cross-sectional area of each coil mounting part to a desired size. The present invention is an inductor as described below in (1) to (4).

(1) An inductor, including: a core that includes coil mounting parts extending in a predetermined Y direction and arranged in the X direction orthogonal to the Y direction; and coils, each coil being externally fitted around each of the coil mounting parts, in which the core is formed to be divided into a plurality of core split bodies, and is installed such that the core split bodies are in contact with each other without providing a gap between the core split bodies, the positions of the end faces on the Z− direction side of the coil mounting parts are aligned with each other in the Z direction, in which the Z− direction is one side of the Z direction that is orthogonal to both the X and Y directions, the position of the end face on the Z+ direction side of at least a predetermined coil mounting part, and the position of the end face on the Z+ direction side of another coil mounting part are different from each other in the Z direction, the Z+ direction being opposite to the Z− direction, and the cross-sectional area of the predetermined coil mounting part and the cross-sectional area of the other coil mounting part are different from each other when viewed in the Y direction.

As per this configuration, the cross-sectional area of each coil mounting part can be adjusted to a desired size by adjusting the position of the end face on the Z+ direction side of each coil mounting part, based on the position of the end face on the Z− direction side of each coil mounting part. As a result, the magnetic resistance at each coil mounting part can be adjusted to the desired level without creating a gap between the core split bodies.

(2) The inductor as described above in (1), in which the core includes a first coil mounting part, a second coil mounting part, and a third coil mounting part, and the positions of the end faces on the Z+ direction side of the coil mounting parts of the core are set such that the magnetic resistances of the path from the first coil mounting part through the second coil mounting part and back to the first coil mounting part, the path from the first coil mounting part through the third coil mounting part and back to the first coil mounting part, and the path from the second coil mounting part through the third coil mounting part and back to the second coil mounting part, are all equal.

With this configuration, equalizing the magnetic resistances of the three paths makes it easier to cancel out the DC component of the magnetic flux passing through each path. This can effectively suppress the magnetic saturation within the core.

(3) The inductor as described above in (1) or (2), in which a cooling section for cooling each of the coils is provided more to the Z− direction side than the core and each of the coils.

With this configuration, the cooling section is provided more to the Z− direction side than the end faces on the Z− direction side of each coil mounting part aligned in the Z direction. As a result, each coil can be cooled. Additionally, the following effects are achieved. If, instead of the end faces on the Z− direction side of the coil mounting parts, the central points in the Z direction of the coil mounting parts were aligned in the Z direction, the following problems would arise. Namely, compared to the end face on the Z− direction side of the coil mounting part which has the greatest width in the Z direction, the end faces on the Z− direction side of the other coil mounting parts would be more distant from the cooling section. As a result, the end on the Z− direction side of the coil externally fitted around the latter coil mounting part would be more distant from the cooling section than the end on the Z− direction side of the coil externally fitted around the former coil mounting part. However, with this configuration, each coil mounting part becomes the closest to the cooling section. Therefore, each coil can be efficiently cooled.

(4) The inductor as described above in (2), in which the coils include a first coil externally fitted around the first coil mounting part, a second coil externally fitted around the second coil mounting part, and a third coil externally fitted around the third coil mounting part, the first coil is part of a first chopper circuit that boosts supplied voltage, the second coil is part of a second chopper circuit that boosts supplied voltage, and the third coil is part of a third chopper circuit that boosts supplied voltage, and the first, second, and third coils are electrically connected to each other in parallel.

With this configuration, for example, the magnetically coupled three-phase inductor that configures part of the boost chopper can achieve the effects of the configurations described in (1) to (3). Additionally, this configuration is not limited to a three-phase system and is also applicable to inductors sharing a plurality of magnetic circuits of four-phase or higher systems.

As described above, with the configuration described in (1), the magnetic resistance at each coil mounting part can be adjusted to the desired level without creating a gap between the core split bodies. Furthermore, the respective additional effects can be obtained by the configurations described in (2) to (4), which quote (1).

### BRIEF DESCRIPTION OF THE DRAWINGS

FIG. 1 is a circuit diagram of a first embodiment;

FIG. 2 is a graph illustrating transition of the current flowing through each coil;

FIG. 3 is a plan view illustrating an inductor;

FIG. 4 is a cross-sectional view along the line IV-IV in FIG. 3;

FIG. 5 is a plan view illustrating an inductor of a comparative embodiment;

FIG. 6 is a cross-sectional view along the line VI-VI in FIG. 5;

FIG. 7 is a circuit diagram of a second embodiment;

FIG. 8 is a circuit diagram of a third embodiment;

FIG. 9 is a plan view illustrating an inductor; and

FIG. 10 is a cross-sectional view along the line X-X in FIG. 9.

### DETAILED DESCRIPTION OF THE INVENTION

Hereinafter, embodiments of the present invention will be described with reference to the drawings. However, the present invention is not limited to the following embodiments and can be implemented with appropriate modifications within a scope that does not deviate from the spirit of the invention.

### First Embodiment

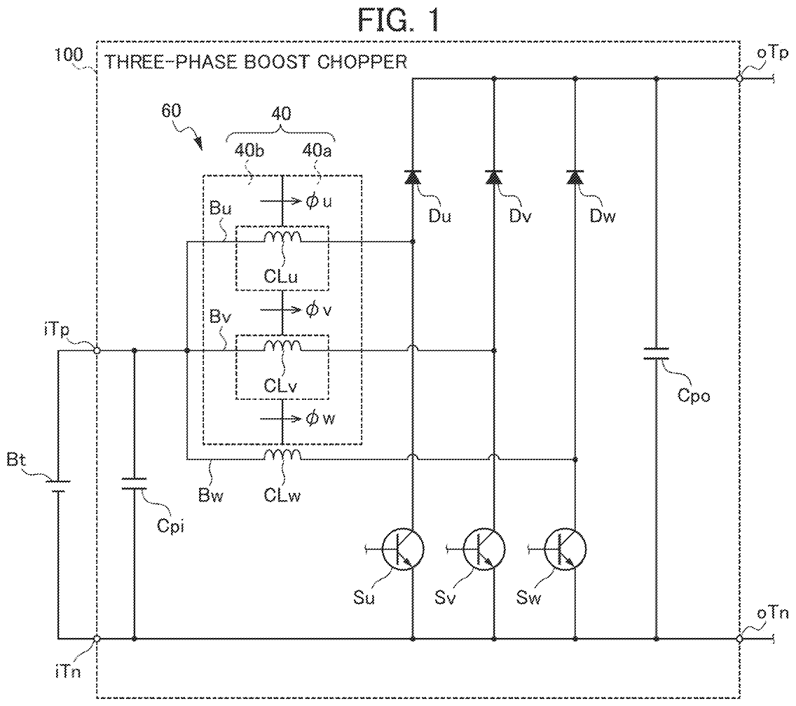

As illustrated in FIG. 1, an inductor 60 of the present embodiment forms part of a three-phase boost chopper 100. The three-phase boost chopper 100 includes input terminals iTp, iTn, an input-side capacitor Cpi, a core 40, three-phase chopper circuits Bu, Bv, Bw, an output-side capacitor Cpo, and output terminals oTp, oTn.

The input terminals iTp, iTn include a positive-side input terminal iTp and a negative-side input terminal iTn. The positive terminal of the battery Bt is electrically connected to the positive-side input terminal iTp, and the negative terminal of the battery Bt is electrically connected to the negative-side input terminal iTn. Hereinafter, the voltage supplied from the battery Bt to the input terminals iTp, iTn is referred to as the “input voltage”.

The three-phase chopper circuits Bu, Bv, Bw include a first chopper circuit Bu, a second chopper circuit Bv, and a third chopper circuit Bw. The first chopper circuit Bu includes a first coil CLu, a first switch Su, and a first diode Du. The second chopper circuit By includes a second coil CLv, a second switch Sv, and a second diode Dv. The third chopper circuit Bw includes a third coil CLw, a third switch Sw, and a third diode Dw.

Hereinafter, the first coil CLu, the second coil CLv, and the third coil CLw are collectively referred to as the “coils CLu, CLv, CLw”. The inductor 60 includes the core 40 and the coils CLu, CLv, CLw externally fitted around the core 40.

Hereinafter, the current flowing through the first coil CLu is referred to as the “first coil current Iu”, the current flowing through the second coil CLv as the “second coil current Iv”, and the current flowing through the third coil CLw as the “third coil current Iw”. Furthermore, the first coil current Iu, the second coil current Iv, and the third coil current Iw are collectively referred to as the “coil currents Iu, Iv, Iw”.

Hereinafter, the magnetic flux flowing along the core 40 is referred to as the core magnetic flux. Moreover, the core magnetic flux generated by the first coil current Iu is referred to as the “first coil magnetic flux φu”, the core magnetic flux generated by the second coil current Iv is referred to as the “second coil magnetic flux φv”, and the core magnetic flux generated by the third coil current Iw is referred to as the “third coil magnetic flux φw”. Additionally, the first coil magnetic flux φu, the second coil magnetic flux φv, and the third coil magnetic flux pw are collectively referred to as the “coil magnetic fluxes φu, φv, φw”.

Next, the first chopper circuit Bu is described in detail. One end of the first coil CLu is electrically connected to both the positive-side input terminal iTp of the entire three-phase boost chopper 100 and the positive terminal of the input-side capacitor Cpi. The other end of the first coil CLu is electrically connected to both the positive terminal of the first switch Su and the anode terminal of the first diode Du. The negative terminal of the first switch Su is electrically connected to the negative-side input terminal iTn of the entire three-phase boost chopper 100, the negative terminal of the input-side capacitor Cpi, the negative terminal of the output-side capacitor Cpo, and the negative-side output terminal oTn of the entire three-phase boost chopper 100. The cathode terminal of the first diode Du is electrically connected to both the positive terminal of the output-side capacitor Cpo and the positive-side output terminal oTp of the entire three-phase boost chopper 100. The first switch Su is a semiconductor switch such as a transistor, MOSFET, or IGBT.

When the first switch Su is turned ON, the first coil current Iu increases, storing magnetic energy in the first coil CLu; when the first switch Su is turned OFF, this magnetic energy is released, thereby outputting a voltage higher than the input voltage from the other end of the first coil CLu. Thus, the first chopper circuit Bu boosts the input voltage.

The details of the second chopper circuit By are similar to those described for the first chopper circuit Bu, with “first” replaced with “second” and the corresponding symbols substituted accordingly. The details of the third chopper circuit Bw are similar to those described for the first chopper circuit Bu, with “first” replaced with “third” and the corresponding symbols substituted accordingly.

As described above, the first, second, and third coils CLu, CLv, CLw are electrically connected to each other in parallel, and the first, second, and third chopper circuits Bu, Bv, Bw collectively boost the input voltage in parallel.

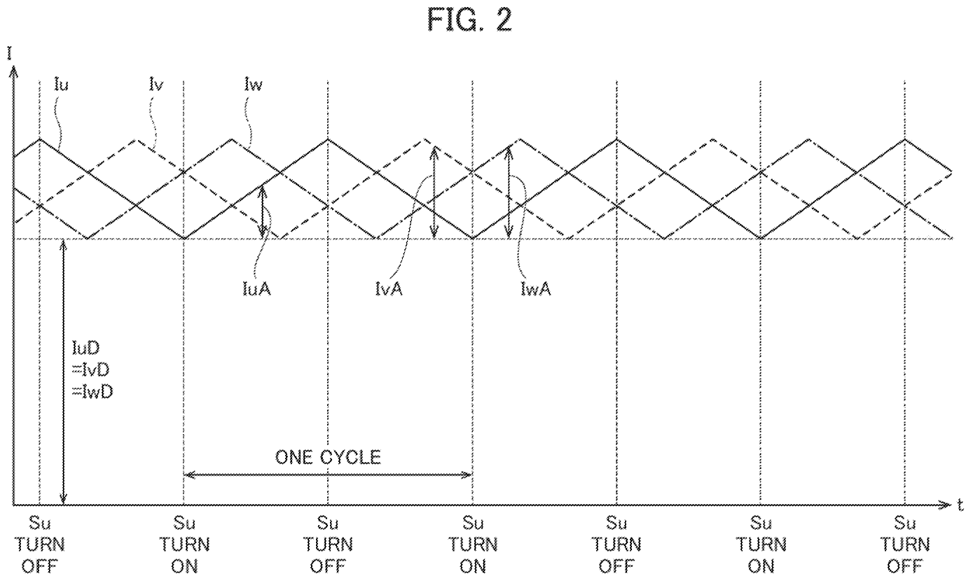

Next, the control of the three-phase chopper circuits Bu, Bv, Bw is described with reference to FIG. 2. Hereinafter, the period from turning ON a switch to turning it OFF and then ON again is referred to as “one cycle”. The three-phase chopper circuits Bu, Bv, Bw are controlled by shifting their phases by one-third of a cycle from each other. In other words, the timings for turning ON the switches Su, Sv, Sw in each phase are staggered by one-third of a cycle from each other. Similarly, the timings for turning them OFF are also staggered by one-third of a cycle from each other.

When the switches Su, Sv, Su are turned ON in each phase, the corresponding coil currents Iu, Iv, Iw in their phases increase. Conversely, when the switches Su, Sv, Su are turned OFF in each phase, the corresponding coil currents Iu, Iv, Iw in their phases decrease. Therefore, the coil currents Iu, Iv, Iw in each phase include DC components IuD, IvD, IwD and AC components IuA, IvA, IwA, respectively. The magnitude of the DC components IuD, IvD, IwD of each coil current is controlled to be equal.

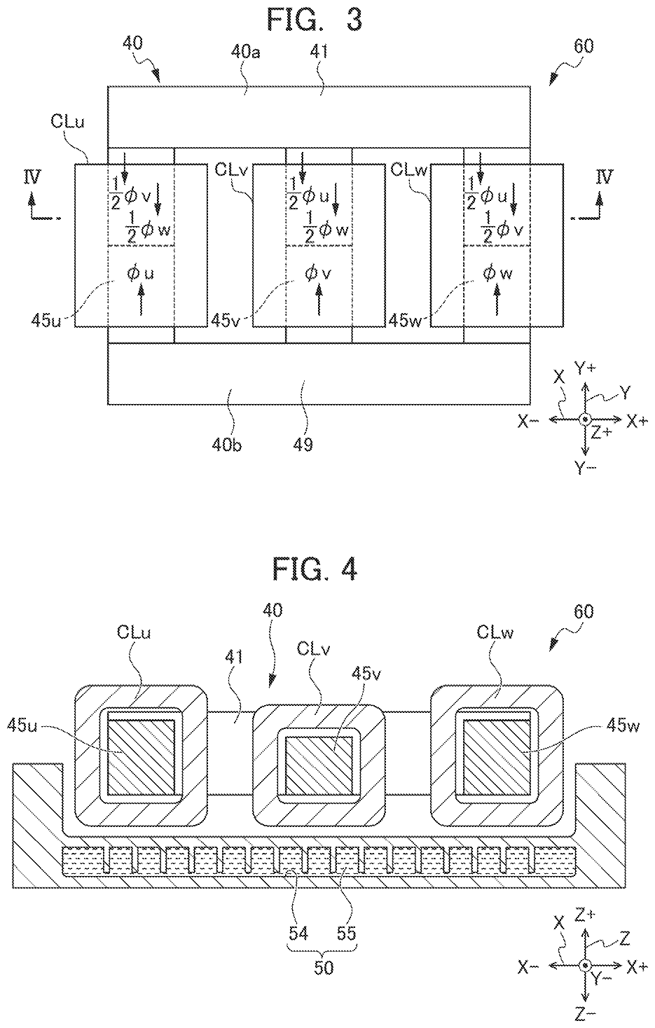

Next, the inductor 60 is described with reference to FIG. 3. Hereinafter, the three mutually orthogonal directions are referred to as “X direction”, “Y direction”, and “Z direction”. One side of the X direction is referred to as the “X− direction”, and its opposite is referred to as the “X+ direction”. Similarly, one side of the Y direction is referred to as the “Y− direction”, and its opposite is referred to as the “Y+ direction”. As illustrated in FIG. 4, one side of the Z direction is referred to as the “Z− direction”, and its opposite is referred to as the “Z+ direction”. In the present embodiment, the Z+ direction is the upward direction. However, the present embodiment may be carried out by defining the Z+ direction as a direction diagonal to the upward direction, or as a horizontal or downward direction.

The core 40 includes three coil mounting parts 45u, 45v, 45w, and first and second connecting parts 41 and 49 that connect them. The three coil mounting parts 45u, 45v, 45w include the first coil mounting part 45u, the second coil mounting part 45v, and the third coil mounting part 45w. The three coil mounting parts 45u, 45v, 45w extend in the Y direction and are aligned in the X direction. The first connecting part 41 connects the ends on the Y+ direction side of the three coil mounting parts 45u, 45v, 45w each other. The second connecting part 49 connects the ends on the Y-direction side of the three coil mounting parts 45u, 45v, 45w each other.

Specifically, the core 40 is formed to be divided into a first core split body 40a and a second core split body 40b. The first core split body 40a includes the first connecting part 41, and the halves on the Y+ direction side of the three coil mounting parts 45u, 45v, 45w. The second core split body 40b includes the second connecting part 49, and the halves on the Y− direction side of the three coil mounting parts 45u, 45v, 45w.

Inside the three coils CLu, CLv, CLw, the end face on the Y− direction side of the first core split body 40a and the end face on the Y+ direction side of the second core split body 40b are in contact. In other words, the core split bodies 40a, 40b are in contact with each other without a gap between the core split bodies 40a, 40b. As a result, the first coil CLu is externally fitted around the first coil mounting part 45u, the second coil CLv is externally fitted around the second coil mounting part 45v, and the third coil CLw is externally fitted around the third coil mounting part 45w.

Hereinafter, within the core 40, the path that goes from the first coil mounting part 45u through the second coil mounting part 45v and back to the first coil mounting part 45u is referred to as the “first-second path 45u-45v”. Within the core 40, the path that goes from the first coil mounting part 45u through the third coil mounting part 45w and back to the first coil mounting part 45u is referred to as the “first-third path 45u-45w”. Within the core 40, the path that goes from the second coil mounting part 45v through the third coil mounting part 45w and back to the second coil mounting part 45v is referred to as the “second-third path 45v-45w”. The first-second path 45u-45v, the first-third path 45u-45w, and the second-third path 45v-45w are collectively referred to as the “three paths 45u-45v, 45u-45w, 45v-45w”.

As illustrated in FIG. 4, the lengths of the three coil mounting parts 45u, 45v, 45w in the X-direction are equal to each other. The positions of the end faces on the Z− direction side of the three coil mounting parts 45u, 45v, 45w are aligned in the Z direction.

The positions of the end faces on the Z+ direction side of the first coil mounting part 45u and the third coil mounting part 45w are equal to each other. Conversely, the position of the end face on the Z+ direction side of the second coil mounting part 45v is located closer toward the Z− direction side than the positions of the end faces on the Z+ direction side of the first coil mounting part 45u and the third coil mounting part 45w. As such, as illustrated in FIG. 4, when viewed in the Y direction, the cross-sectional area of the second coil mounting part 45v is smaller than the cross-sectional area of the first coil mounting part 45u or the cross-sectional area of the third coil mounting part 45w.

Thus, as illustrated in FIG. 3, in the core 40, the magnetic resistances of the first-second path 45u-45v, the first-third path 45u-45w, and the second-third path 45v-45w are equal. Consequently, the DC components of the core magnetic fluxes in the paths 45u-45v, 45u-45w, 45v-45w are canceled out. The reasons for this will be described later.

As illustrated in FIG. 4, a cooling section 50 is provided on the Z− direction side, which is further than the core 40 and the three coils CLu, CLv, CLw. The cooling section 50 cools the core 40 and the three coils CLu, CLv, CLw. For instance, the cooling section 50 includes a flow path 54, through which a coolant 55 such as cooling water flows.

Next, the reason why the DC components of the core magnetic fluxes are canceled out in the paths 45u-45v, 45u-45w, 45v-45w is described with reference to FIG. 3.

In the first coil mounting part 45u, all of the first coil magnetic flux φu flows, while part of the second coil magnetic flux φv and part of the third coil magnetic flux (pw flow in the opposite direction. As previously mentioned, since the magnetic resistances of the first-second path 45u-45v and the second-third path 45v-45w are equal, the second coil magnetic flux φv is evenly split between the first-second path 45u-45v and the second-third path 45v-45w. Similarly, since the magnetic resistances of the first-third path 45u-45w and the second-third path 45v-45w are equal, the third coil magnetic flux (pw is evenly split between the first-third path 45u-45w and the second-third path 45v-45w.

Therefore, in the first coil mounting part 45u, all of the first coil magnetic flux φu flows, while exactly half of the second coil magnetic flux φv and exactly half of the third coil magnetic flux (pw flow in the opposite direction. Hence, if the magnitudes of the first coil magnetic flux φu, the second coil magnetic flux φv, and the third coil magnetic flux (pw are equal to each other, they will be perfectly canceled out without any excess or deficit.

As previously mentioned, and as illustrated in FIG. 2, the DC components IuD, IvD, IwD of each coil current are equal to each other. Therefore, the DC components of the magnetic fluxes φu, φv, (pw generated by them are also equal to each other. As a result, the DC component of the core magnetic flux flowing in the first coil mounting part 45u illustrated in FIG. 3 is perfectly canceled out without any excess or deficit. Similarly, the DC components of the core magnetic fluxes w flowing in the second coil mounting part 45v and the third coil mounting part 45w are also perfectly canceled out without any excess or deficit.

Hereinafter, an embodiment illustrated in FIG. 6, modified from the present embodiment illustrated in FIG. 4, is referred to as a comparative embodiment. In this comparative embodiment, the position of the end face on the Y+ direction side of the second coil mounting part 45v is aligned with the positions of the end faces on the Y+ direction sides of the first coil mounting part 45u and the third coil mounting part 45w. As such, as illustrated in FIG. 6, when viewed in the Y direction, the cross-sectional areas of the three coil mounting parts 45u, 45v, 45w are equal to each other.

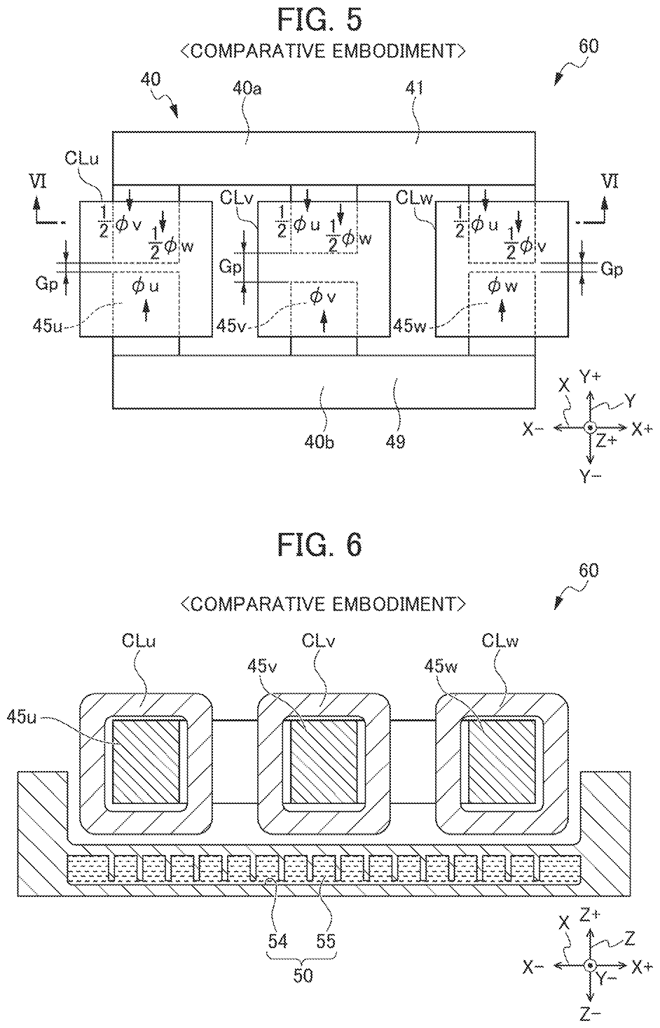

As illustrated in FIG. 5, in the comparative embodiment, a gap Gp is provided between the first core split body 40a and the second core split body 40b. The gap Gp in the second coil mounting part 45v is larger than the gaps Gp in the first coil mounting part 45u or the third coil mounting part 45w. As a result, the magnetic resistances in the three paths 45u-45v, 45u-45w, 45v-45w are equalized.

Comparing the present embodiment with the comparative embodiment as described above, the configuration and effects of the present embodiment are summarized as follows.

In the comparative embodiment illustrated in FIG. 5, the magnetic resistance in each path 45u-45v, 45u-45w, 45v-45w can be adjusted to the desired level by adjusting the sizes of the three gaps Gp. However, during the assembly of the inductor 60, a process is required to insert and adhere a member to form the gap Gp, which increases the number of steps and the effort involved. Moreover, when the gaps Gp to be managed are thin, accurate adjustment to the desired size is difficult.

In contrast, in the present embodiment as illustrated in FIG. 4, the positions of the ends on the Z+ direction side of each of the coil mounting parts 45u, 45v, 45w are adjusted based on the positions of the ends on the Z− direction side of each of the coil mounting parts 45u, 45v, 45w. This adjusts the cross-sectional areas of each coil mounting part 45u, 45v, 45w to the desired size. As a result, as illustrated in FIG. 3, the magnetic resistance at each coil mounting part 45u, 45v, 45w can be adjusted to the desired level without creating a gap between the core split bodies 40a, 40b.

Furthermore, by not creating a gap, if the same magnetic resistance as in the case with a gap is acceptable, the circumferential length around each coil mounting part 45u, 45v, 45w can be reduced. In particular, the circumferential length around the second coil mounting part 45v can be noticeably reduced. Consequently, the total length of each coil CLu, CLv, CLw can be reduced, particularly and noticeably for the second coil CLv.

Also, in the core 40 illustrated in FIG. 3, the magnetic resistances of the first-second path 45u-45v, the first-third path 45u-45w, and the second-third path 45v-45w are equal to each other. Therefore, as mentioned above, it becomes easier to cancel out the DC components of the coil magnetic fluxes φu, φv, φw in each path 45u-45v, 45u-45w, 45v-45w. This helps to efficiently suppress the magnetic saturation and the heat generation within the core 40.

As illustrated in FIG. 4, the cooling section 50 is provided on the Z− direction side, beyond the end faces aligned in the Z direction on the Z− direction side of each coil mounting part 45u, 45v, 45w. Therefore, all three of the coils CLu, CLv, CLw can be evenly cooled. Additionally, the following effects are achieved. If, instead of the end faces on the Z− direction side of each coil mounting part 45u, 45v, 45w, the central points in the Z direction of each coil mounting part were aligned in the Z direction, the problem outlined below would arise. Namely, compared to the end faces on the Z− direction side of the first and third coil mounting parts 45u, 45w, which have the greatest width in the Z direction, the end face on the Z− direction side of the second coil mounting part 45v would be more distant from the cooling section 50. As a result, the end on the Z− direction side of the second coil CLv would be more distant from the cooling section 50 than the ends on the Z− direction side of the first and third coils CLu, CLw. However, in the present embodiment, all of the coil mounting parts 45u, 45v, 45w are positioned closest to the cooling section 50. Thus, all of the coils CLu, CLv, CLw can be efficiently cooled.

Additionally, as illustrated in FIG. 1, the inductor 60 configures part of the three-phase boost chopper 100. Therefore, the inductor 60 of the three-phase boost chopper 100 achieves the effects as mentioned above.

### Second Embodiment

Next, a second embodiment will be described. The present embodiment is explained based on the first embodiment, focusing on differences, and the description is appropriately omitted where the points are the same or similar to the first embodiment.

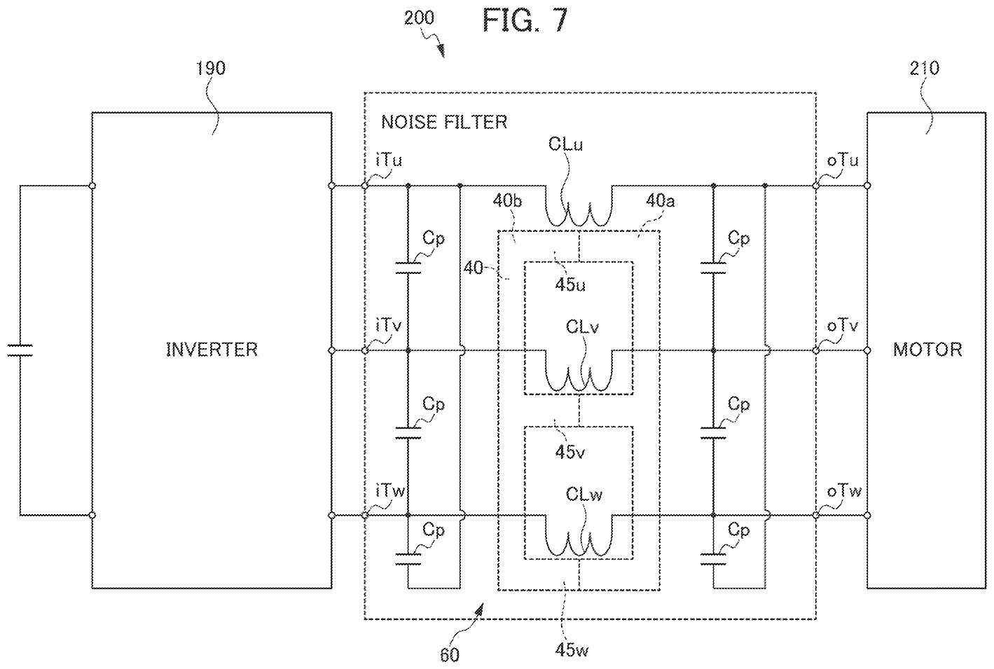

As illustrated in FIG. 7, the inductor 60 in the present embodiment configures part of a noise filter 200. The noise filter 200 is interposed between a three-phase AC inverter 190 and a motor 210.

The noise filter 200 includes input terminals iTu, iTv, iTw, the core 40, the three-phase coils CLu, CLv, CLw, six capacitors Cp, and output terminals oTu, oTv, oTw. The input terminals iTu, iTv, iTw include a first input terminal iTu, a second input terminal iTv, and a third input terminal iTw. The output terminals oTu, oTv, oTw include a first output terminal oTu, a second output terminal oTv, and a third output terminal oTw.

The first input terminal iTu is electrically connected to the first output terminal oTu through the first coil CLu. The second input terminal iTv is electrically connected to the second output terminal oTv through the second coil CLv. The third input terminal iTw is electrically connected to the third output terminal oTw through the third coil CLw.

Within the noise filter 200, the pair of input terminals iTu-iTv, iTv-iTw, iTw-iTu are electrically connected to each other through the capacitor Cp. Within the noise filter 200, the pair of output terminals oTu-oTv, oTv-oTw, oTw-oTu are electrically connected to each other through the capacitor Cp.

According to the present embodiment, in the inductor 60 of the noise filter 200, the magnetic resistance at each coil mounting part 45u, 45v, 45w can be adjusted to the desired level without creating a gap between the core split bodies 40a, 40b.

### Third Embodiment

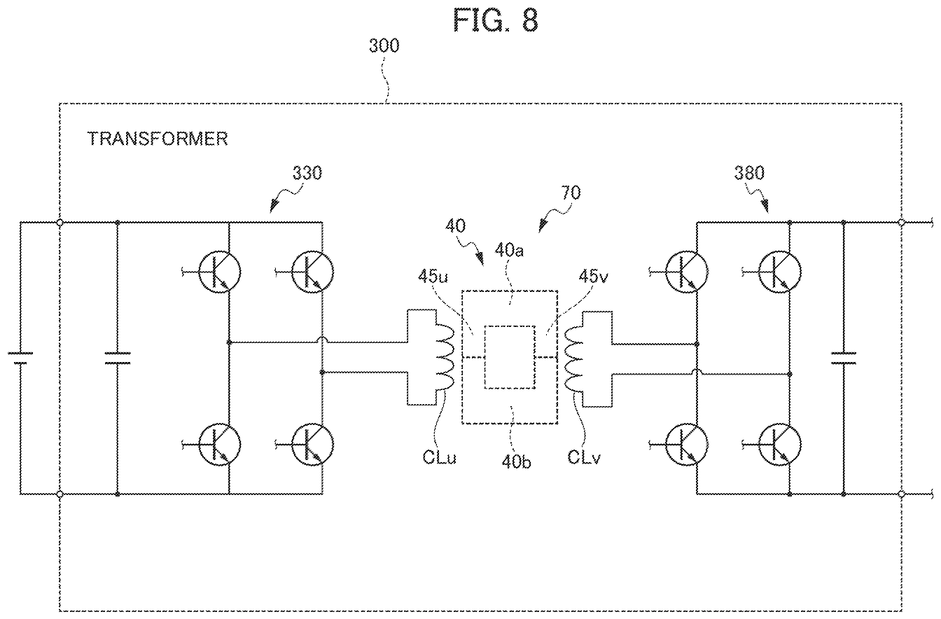

Next, a third embodiment will be described. As illustrated in FIG. 8, an inductor 70 in the present embodiment configures part of a transformer 300. The transformer 300 includes an input-side full bridge circuit 330 and an output-side full bridge circuit 380. The first coil CLu is electrically connected to the input-side full bridge circuit 330, and the second coil CLv is electrically connected to the output-side full bridge circuit 380. The number of windings of the second coil CLv is greater than that of the first coil CLu.

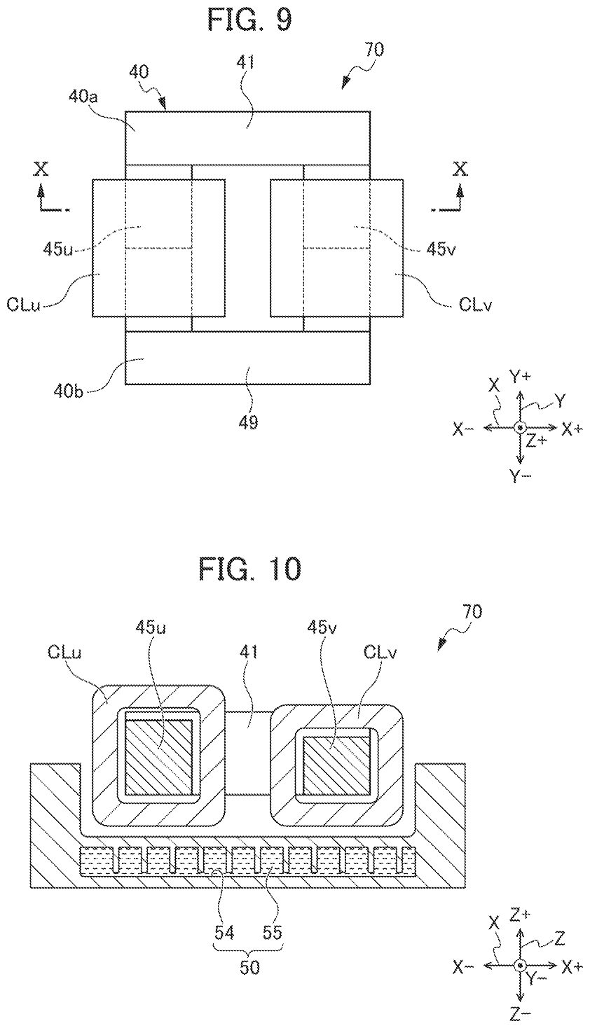

As illustrated in FIG. 9, the core 40 does not have the third coil mounting part 45w which exists in the first embodiment. The first connecting part 41 connects the ends on the Y+ direction side of the first and second coil mounting parts 45u, 45v to each other, and the second connecting part 49 connects the ends on the Y− direction side of the first and second coil mounting parts 45u, 45v to each other.

As illustrated in FIG. 10, when viewed in the Y direction, the cross-sectional area of the second coil mounting part 45v is smaller than the cross-sectional area of the first coil mounting part 45u. This is similar to the first embodiment.

According to the present embodiment, the first and second coil mounting parts 45u, 45v can each meet their respective priorities. Specifically, for the first coil mounting part 45u illustrated in FIG. 9, since the number of windings of the first coil CLu is relatively low, it is preferable to prioritize a larger cross-sectional area to reduce the magnetic resistance of the core 40 as a whole, rather than prioritizing a smaller cross-sectional area to reduce the total length of the first coil CLu. On the other hand, for the second coil mounting part 45v, since the number of windings of the second coil CLv is relatively high, it is preferable to prioritize a smaller cross-sectional area to reduce the total length of the second coil CLv.

In this regard, as illustrated in FIG. 10, the end face on the Z+ direction side of the first coil mounting part 45u is positioned relatively towards the Z+ direction, making the cross-sectional area relatively larger. Conversely, the end face on the Z+ direction side of the second coil mounting part 45v is positioned relatively towards the Z− direction, making the cross-sectional area relatively smaller. As a result, the first and second coil mounting parts 45u, 45v can each meet their respective priorities.

As described above, according to the present embodiment, as illustrated in FIG. 9, in the inductor 60 of the transformer 300, the magnetic resistance at each coil mounting part 45u, 45v can be adjusted to the desired level without creating a gap between the core split bodies 40a, 40b.

### Other Embodiments

The embodiments illustrated above can be modified, for example, in the following manner. The core 40 may be divided into three or more parts. The core 40 may be split at positions different from those in the first embodiment or similar cases. The number of coil mounting parts may be increased to four or more, and the number of coils may be increased to four or more. In the first embodiment, the three-phase chopper circuits Bu, Bv, Bw may be controlled with the same phase.

### EXPLANATION OF REFERENCE NUMERALS

40: core
40a: first core split body
40b: second core split body
45u: first coil mounting part
45v: second coil mounting part
45w: third coil mounting part
50: cooling section
60: inductor
70: inductor
100: three-phase boost chopper
Bu: first chopper circuit
Bv: second chopper circuit
Bw: third chopper circuit
CLu: first coil
CLv: second coil
CLw: third coil
Gp: gap

What is claimed is:

1. An inductor, comprising:
a core that includes coil mounting parts extending in a predetermined Y direction and arranged in an X direction orthogonal to the Y direction; and
coils, each coil being externally fitted around each of the coil mounting parts, wherein
the core is formed to be divided into a plurality of core split bodies, and is installed such that the core split bodies are in contact with each other without providing a gap between the core split bodies,
positions of end faces on a Z− direction side of the coil mounting parts are aligned with each other in a Z direction, the Z− direction being one side of the Z direction that is orthogonal to both the X and Y directions,
a position of an end face on a Z+ direction side of at least a predetermined coil mounting part, and a position of an end face on the Z+ direction side of another coil mounting part are different from each other in the Z direction, the Z+ direction being opposite to the Z− direction, and
a cross-sectional area of the predetermined coil mounting part and a cross-sectional area of the other coil mounting part are different from each other when viewed in the Y direction.

2. The inductor according to claim 1, wherein
the core includes a first coil mounting part, a second coil mounting part, and a third coil mounting part, and
positions of end faces on the Z+ direction side of the coil mounting parts of the core are set such that magnetic resistances of a path from the first coil mounting part through the second coil mounting part and back to the first coil mounting part, a path from the first coil mounting part through the third coil mounting part and back to the first coil mounting part, and a path from the second coil mounting part through the third coil mounting part and back to the second coil mounting part, are all equal.

3. The inductor according to claim 1, wherein a cooling section for cooling each of the coils is provided more to the Z− direction side than the core and each of the coils.

4. The inductor according to claim 2, wherein
the coils include a first coil externally fitted around the first coil mounting part, a second coil externally fitted around the second coil mounting part, and a third coil externally fitted around the third coil mounting part,
the first coil is part of a first chopper circuit that boosts supplied voltage,
the second coil is part of a second chopper circuit that boosts supplied voltage, and
the third coil is part of a third chopper circuit that boosts supplied voltage, and
the first, second, and third coils are electrically connected to each other in parallel.
